(19) United States
(12) Patent Application Publication
(10) Pub. No.: US 2024/0348885 A1
(43) Pub. Date: Oct. 17, 2024

(54) SYSTEM AND METHOD FOR QUESTION ANSWERING

(71) Applicant: InterDigital CE Patent Holdings, SAS, Paris (FR)

(72) Inventors: Quang Khanh Ngoc Duong, Rennes (FR); Deniz Engin, Rennes (FR); Francois Schnitzler, Saint Ave (FR); Yannis Avrithis, Vrilissia (GR)

(21) Appl. No.: 18/292,252

(22) PCT Filed: Jul. 27, 2022
(86) PCT No.: PCT/EP2022/071087

§ 371 Date: Jan. 25, 2024

(30) Foreign Application Priority Data
Jul. 28, 2021 (EP) 21306054.4

(51) Int. Cl. H04N 21/4722; H04N 21/431; H04N 21/44

(52) U.S. Cl. CPC H04N 21/4722; H04N 21/4316; H04N 21/44008

(57) ABSTRACT

A method and a system for providing an answer to a query from a user, for example about video content. The system receives a query, generates a video clip that corresponds to the question, and provides the video clip for presentation to the user. The question can for example be about an event in a TV series or a film, or about an activity recorded by a video surveillance system.

### TECHNICAL FIELD

The present disclosure relates generally to Artificial Intelligence and in particular to video question answering.

### BACKGROUND

This section is intended to introduce the reader to various aspects of art, which may be related to various aspects of the present disclosure that are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Supported by high communication bandwidth and advanced smart technologies, video streaming services continue to emerge with more and more big players like Netflix, Amazon Prime Video, Apple TV, Disney+, Salto, etc. Video-on-demand has become a clear trend where users are free to choose whatever content they want to watch at any time on their CE devices (smart TV, smartphone, tablet, PC, etc) via a streaming service. Due to a large amount of content (i.e. TV series with many episodes, long movies), users may miss important information when they do not fully concentrate or watch all the content (e.g. sometimes users take a phone call, cook, or do other things while watching TV shows/movies, or they even miss a full episode as there are many). In such situations, when experiencing current content and realizing that important information has been missed, a user may wish to ask the CE device (such as smart TV) to provide a summary concerning the missing information they ask for via a question-answering (QA) interface.

Strongly supported by advances in artificial intelligence (AI), question-answering has emerged recently for improved living experience, where people look for a seamless interface to communicate with CE devices. QA has become a crucial feature in smart home devices such as Amazon Echo, Google Home, Facebook Postal, etc. However, current device tend to make use of microphones to capture user commands (using automatic speech recognition technology) in order to help users perform simple things like accessing media, managing simple tasks, and planing a day.

As a starting point for the living assistance, visual question answering (VQA) [see e.g. Aishwarya Agrawal, “VQA: Visual Question Answering,” 2016, arXiv: 1505.00468v7, and Yash Goyal et al., “Making the V in VQA Matter: Elevating the Role of Image Understanding in Visual Question Answering,” 2017, arXiv: 1612.00837v3] and visual dialog [see e.g. A. Das et al., “Visual dialog,” Proc. CVPR, 2017], which require an Artificial Intelligence (AI) system to have a meaningful dialog with humans in conversational language about visual content, have received recent attention by the research community.

In a simple case, given an input image and a natural language question about the image, the VQA task is to provide an accurate natural language answer. Moving towards video very recently, where the user can ask questions concerning what is contained or happens in a video, Fan et al. proposed an end-to-end trainable Video Question Answering (VideoQA) framework via deep neural networks (DNN) [see Heterogeneous Memory Enhanced Multimodal Attention Model for Video Question Answering]. In “Knowledge-Based Video Question Answering with Unsupervised Scene Descriptions,” Garcia and Nakashima presented another DNN-based Knowledge-Based Video Question Answering targeting movie data bases, which provides an answer by fusing answer scores computed from different modalities: current scene dialogues, generated video scene descriptions, and external knowledge—notably, plot summary—generated by human experts. Lei et al. built a large-scale TVQA dataset from six popular TV shows, which enables VideoQA research applied in real TV shows [see TVQA: Localized, Compositional Video Question Answering]. In “On the hidden treasure of dialog in video question answering,” Engin et al. proposed a new approach to understand the whole story in a video via dialog reasoning. It is noted that VideoQA typically requires a higher level of reasoning than dialog or image-based QA to understand complex events.

However it may be unsatisfactory for a user to obtain a text response to a question. It will thus be appreciated that there is a desire for a solution that addresses at least some of the shortcomings of answer systems. The present principles provide such a solution.

### SUMMARY OF DISCLOSURE

In a first aspect, the present principles are directed to a method comprising receiving a query originating from a user, generating a video clip that corresponds to an answer to the question, and providing the video clip for presentation to the user.

In a second aspect, the present principles are directed to a system comprising an interface configured to receive a query originating from a user, and a processor configured to generate a video clip that corresponds to an answer to the question, and provide the video clip for presentation to the user.

In a third aspect, the present principles are directed to a computer program product which is stored on a non-transitory computer readable medium and includes program code instructions executable by a processor for implementing the steps of a method according to any embodiment of the first aspect.

### BRIEF DESCRIPTION OF DRAWINGS

Features of the present principles will now be described, by way of non-limiting example, with reference to the accompanying drawings, in which:

FIG. 1 illustrates a system for answer generation and presentation according to an embodiment of the present principles;

FIGS. 2A-2C illustrate different implementations according to embodiments of the present principles;

FIG. 3 illustrates a system for answer generation according to an embodiment of the present principles; and

FIG. 4 illustrates a method for providing a video answer to a user question according to an embodiment of the present principles.

### DESCRIPTION OF EMBODIMENTS

Answering a query, such as a question (that will be used throughout the description), for example about a video content often requires to look at the present or the past or remember the past. Recent advances in VideoQA allow computer systems to perform this complicated task automatically. When searching for the answer, the VideoQA can also localize the video segment that most contributes to the answer.

According to the present principles, the VideoQA also extracts one or more key video segments (e.g. with start frame and end frame indices) corresponding to the answer to the user's question, e.g. explaining or showing the answer. These key video segments are presented to the user on a main screen, i.e. the screen on which the user is watching content or typically watches content, (e.g. using picture-in-picture mode) or on a second screen. The key video segments can enhance user experience, for example while watching content via video streaming services and/or interacting with intelligent CE devices.

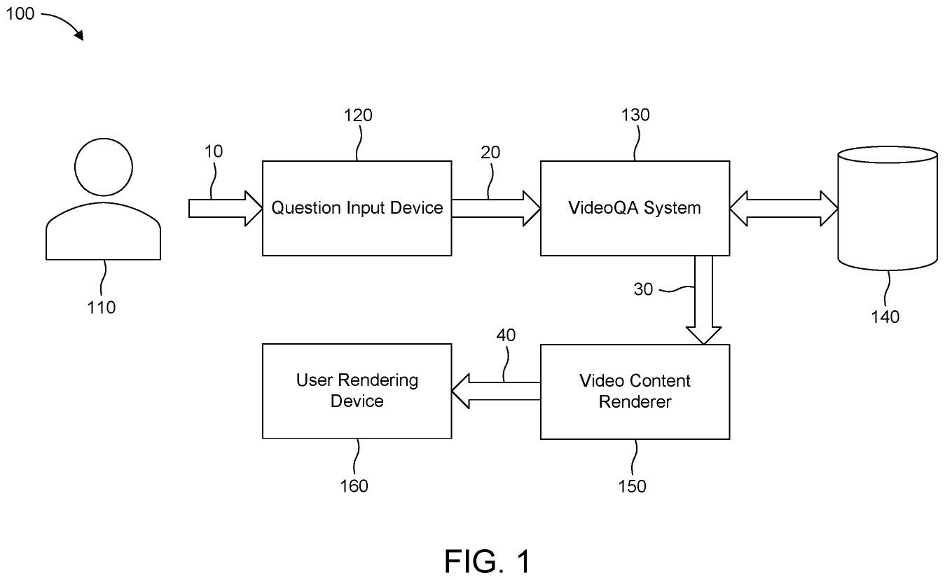

FIG. 1 illustrates a system 100 according to an embodiment of the present principles.

User 100 can input a question (or questions) 10 using audio (e.g. speech), text (e.g. typed using a keyboard) or gestures (e.g. sign language) to a question input device 120, as is well known in the art.

The question input device 120 (for example a smart TV, smartphone, PC, smart home assistant, etc.) can use conventional solutions (e.g. automatic speech recognition) to transform or interpret the question 10 inputted by the user 100 into an processed question 20 in a format, such as plain text, understandable in the system 100, notably by VideoQA system 130.

The VideoQA system 130 receives the processed question 20 and analyzes video content in a Video database 140 to find a relevant answer, which for example may be textual (i.e. non-video), to the question. The VideoQA system 130 typically has a deep neural network (DNN) architecture focusing on multimodal embeddings/description (for audio, visual and text information), temporal attention and localization to focus on the important part of the video, and multimodal fusion and reasoning. It can be implemented by state-of-the-art AI/ML models such as those proposed by Lei and Engin; see the background section.

As mentioned, instead of providing a textual answer (written or vocal) as conventional QA systems do, the VideoQA system according to the present principles provides a video clip 30 comprising one or more key video segments, possibly in addition to such a textual answer. The video clip can for example be from a few seconds to some minutes in length and correspond to one or several events (e.g. video segments in streamed content or video segments recorded by camera at home environment) highlighting the answer.

Selection of the key video segments can be based on the one or more segments that contribute the most to the answer, as already mentioned. The key video segments can be edited and combined using conventional methods to obtain the video clip 30.

As an alternative, selection of the key video segments could be realized by directly training a system to output a relevant video. For example, rather than using one or multiple correct answers as labels, the training procedure would use as labels the start and end of a proper video clip or any other method to describe one or multiple video clip(s).

The video clip 30 is provided, for example using streaming, to a video content renderer 150, for example a decoder, that is configured to process the video clip 30 to output a processed video clip 40 to a user rendering device 160.

The user rendering device 160 is configured to display (i.e. render, present) the corresponding video clip to the user 110. The user rendering device 160 can be a main screen (e.g. tablet or smart TV) on which the video clip can be presented using picture-in-picture, for example while viewing the video content as the main content, or as the main content. The user rendering device 160 can also be a second screen, different from the main screen, for example a smartphone or a tablet.

It is noted that two or more of at least the question input device 120, the video content renderer 150 and the user rendering device 160 can be combined in various ways. For example, a tablet can implement all three of these in a device that can be used to receive the user's question, receive and render the video clip.

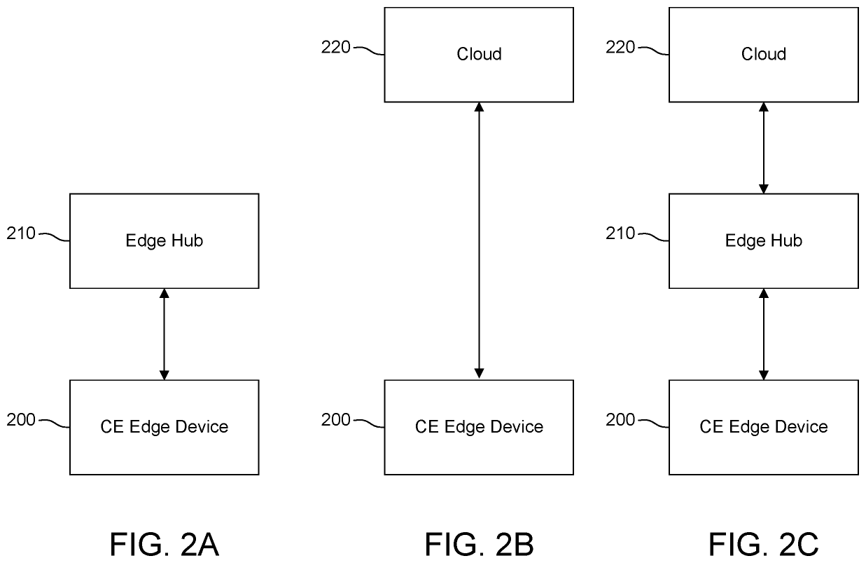

FIGS. 2A-2C illustrate different implementations according to embodiments of the present principles. The embodiments correspond to different distributions of the VideoQA system and the Video content renderer 15 illustrated in FIG. 1.

FIG. 2A illustrates how the VideoQA system and the Video content renderer, and possibly also further pre- and postprocessing functionality for the question and answer are implemented in an Edge Hub 210 separate from the CE edge device 200 on which the answer will be displayed to the user.

FIG. 2B illustrates how the VideoQA system and the Video content renderer, and possibly also further pre- and postprocessing functionality for the question and answer are implemented in the Cloud 220 separate from the CE edge device 200 on which the answer will be displayed to the user.

FIG. 2C illustrates an embodiment in which the question pre-processing, the Video content renderer, and the answer post-processing step are implemented in the Edge hub 210, while the VideoQA block that typically requires more computational resources is located the Cloud 220; the answer is still provided to the user on the CE edge device 200.

The Edge hub 210 can be implemented in devices like a smart TV, gateway, STB, smart assistant, or stand-alone devices. It is thus noted that the Edge hub 210 and the CE edge device 200 can be implemented as a single device.

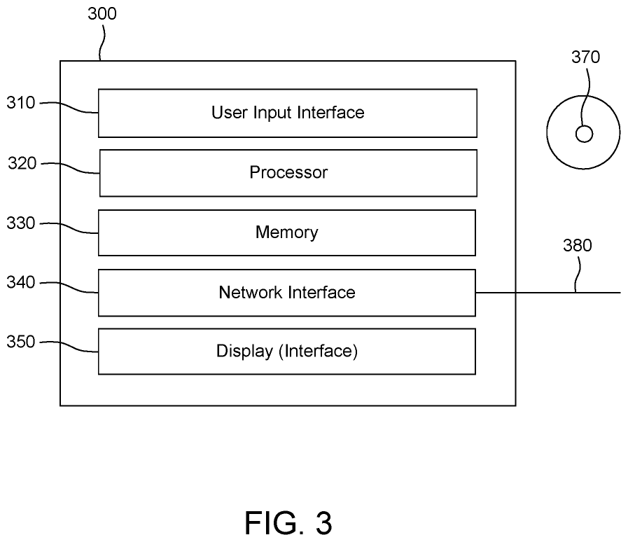

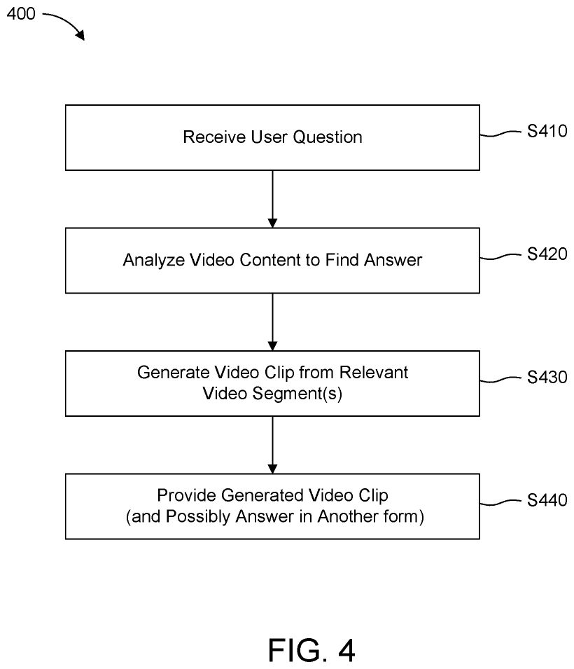

FIG. 3 illustrates a system 300 for answer generation according to an embodiment of the present principles. The system 300 typically includes a user input interface 310, at least one hardware processor (“processor”) 320, memory 330, and a network interface 340. The device 300 can further include a display interface or a display 350. A non-transitory storage medium 370 stores computer-readable instructions that, when executed by a processor, perform the method described with reference to the method described in FIG. 4.

The user input interface 310, which for example can be implemented as a microphone, a keyboard, a mouse, a touch screen or a combination of two or more input possibilities, is configured to receive input from a user. The processor 320 is configured to execute program code instructions to perform a method according to at least one method of the present principles. The memory 330, which can be at least partly non-transitory, is configured to store the program code instructions to be executed by the processor 320, parameters, image data, intermediate results and so on. The network interface 340 is configured for communication with external devices (not shown) over any suitable connection 380, wired or wireless.

FIG. 4 illustrates a method 400 for providing a video answer to a user question according to an embodiment of the present principles. The method is typically implemented by a VideoQA system (130 in FIG. 1).

In step S410, the VideoQA system receives the question originating from a user. In case the question has not been (sufficiently) processed, the step can include processing to obtain a question usable by the VideoQA system.

In step S420, the VideoQA system analyzes video content in a Video database to find a relevant answer to the question, as already explained.

In step S430, the VideoQA system generates a video clip from relevant video segments, i.e. video segments that contribute (the most) to the answer.

In step S440, the VideoQA system provides (i.e. sends) the generated video clip, possibly together with the answer in another form (e.g. textual) for distribution to an end device destined to render the video clip to the user.

### Smart TV Assistant

In an embodiment, the user can ask questions for information about or for an answer about what happened in a TV show, movie, sport program, etc.

Taking a TV show as an example, the user may miss part or more of a previous episode and wants information about it. Recent approaches, such as KnowIT VQA presented by Garcia and Nakashima or that described by Engin et al. allow a VideoQA system to answer questions related to one or more video scenes, an episode or the entire TV show. Such systems also allow to localize at least one video segment that is relevant to the answer, so that it can be visualized in the TV screen, owing to the temporal attention mechanism in the designed architecture. For TV shows or movies, dialog (in form of subtitle) and human-generated plot summaries are usually available as an important source of high-level information, which helps answer knowledge questions.

As such, the user can input a question to which the VideoQA system responds with visual content, such as a summary, possibly accompanied by further information such as narrative speech.

### Home Assistant

Video recordings can also be available in home environments for assistance or surveillance purposes.

In an embodiment, user such as parents may for instance be interested in knowing what their children did during the day, who left the television running, how a delivery was made or where a particular object is (and how it ended up where it is). In this case, the users can ask a question to a smart home assistant device that analyzes visual information in the recorded video database to find relevant video segments to show on a screen. For the examples above, these segments could respectively show what the children did, the last person leaving the television area, the delivery, or the person leaving the object in the place where it is.

It is noted that VideoQA techniques such as those provided by Lei et al., Garcia and Nakashima, and Engin et al. can also work with visual information extracted from video scenes only (without text information from dialog or plot summary as in case of TV programs), so they can be implemented in this home setting.

The query can also be about other events not necessarily linked to a specific item of video. For example, the query can be about the weather in a particular place and the answer can then be a video showing the weather in the place in question.

As will be appreciated, the functionality can be implemented in a single device, or split over a plurality of devices, in the home, in the Edge hub and/or the Cloud.

As will be appreciated, the present embodiments can improve question answering systems.

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces.

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read only memory (ROM) for storing software, random access memory (RAM), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

1. A method performed by at least one processor and comprising:
receiving, during provision of a video content, the video content being an episode of a TV show, a question relating to a previous episode of the TV show, the question originating from a user;
generating a video clip that corresponds to an answer to the question; and
providing the video clip for presentation to the user.

2. (canceled)

3. The method of claim 1, wherein the question is about at least one event in the previous episode of the TV show.

4. The method of claim 1, wherein the video clip is generated from the previous episode of the TV show.

5. The method of claim 4, wherein the video clip is generated from at least one video segment of the previous episode of the TV show.

6. The method of claim 1, wherein the answer to the question is obtained by analyzing the previous episode of the TV show.

7-9. (canceled)

10. The method of claim 5, wherein generating the video clip comprises at least one of editing and combining the at least one video segment.

11. (canceled)

12. The method of claim 1, wherein the video clip and the video content are provided simultaneously to the user.

13. The method of claim 12, wherein the video clip and the video content are provided using picture-in-picture technology.

14. The method of claim 1, further comprising providing, to the user, a text answer to the question.

15. A system comprising:
an interface configured to receive, during provision of a video content, the video content being an episode of a TV show, a question relating to a previous episode of the TV show, the question originating from a user; and
a processor configured to:
generate a video clip that corresponds to an answer to the question; and
provide the video clip for presentation to the user.

16. (canceled)

17. The system of claim 15, wherein the question is about at least one event in the previous episode of the TV show.

18. The system of claim 15, wherein the processor is configured to generate the video clip from the previous episode of the TV show.

19. The system of claim 18, wherein the processor is configured to generate the video clip from at least one video segment of the previous episode of the TV show.

20. The system of claim 15, wherein the processor is configured to obtain the answer to the query by analyzing the previous episode of the TV show.

21-23. (canceled)

24. The system of claim 19, wherein the processor is configured to generate the video clip by at least one of editing and combining the at least one video segment.

25. (canceled)

26. The system of claim 15, wherein the processor is further configured to provide the video clip and the video content simultaneously to the user.

27. The system of claim 26, wherein the processor is further configured to provide the video clip and the video content using picture-in-picture technology.

28-29. (canceled)

30. A non-transitory computer-readable storage medium storing instructions that, when executed, cause at least one hardware processor perform the method of claim 1.

31. The method of claim 12, wherein the video content is provided on a first screen and the video clip is provided on a second screen.

32. The method of claim 26, wherein the video content is provided on a first screen and the video clip is provided on a second screen.
